(19) United States
(12) Patent Application Publication
(10) Pub. No.: US 2025/0245895 A1
(43) Pub. Date: Jul. 31, 2025

(54) TRANSFORMABLE AVATAR IN DRESSING VISUALIZATION

(71) Applicant: Walmart Apollo, LLC, Bentonville, AR (US)

(72) Inventor: Georgy Melamed, Ramat Gan (IL)

(73) Assignee: Walmart Apollo, LLC, Bentonville, AR (US)

(21) Appl. No.: 19/041,198

(22) Filed: Jan. 30, 2025

Related U.S. Application Data
(60) Provisional application No. 63/626,651, filed on Jan. 30, 2024.

(51) Int. Cl. G06T 11/60; G06F 3/04845; G06F 3/04847; G06T 7/70

(52) U.S. Cl. CPC G06T 11/60; G06F 3/04845; G06F 3/04847; G06T 7/70; G06T 2200/24; G06T 2207/20081; G06T 2207/30196; G06T 2210/16

(57) ABSTRACT

A system including a processor and a non-transitory computer-readable media storing computing instructions that, when executed on the processor, cause the processor to perform certain operations. The operations can include extracting shape and pose vectors of an image of a user. The operations also can include generating a virtual image representing the user based on the shape and pose vectors and apparel of interest. The operations further can include receiving, from the user through an interactive user interface, one or more adjustments on a temporal axis to modify parameters of the virtual image over one or more time periods. The operations additionally can include updating a model for the user based on the one or more adjustments on the temporal axis and a change model trained on the temporal axis. The operations further can include rendering a modified virtual image of the user based on the model for the user, as updated, and the apparel of interest. The operations also can include sending the modified virtual image of the user for display on the interactive user interface. Other embodiments are described.

### CROSS-REFERENCE TO RELATED APPLICATION

This application claims the benefit of U.S. Provisional Application No. 63/626,651, filed Jan. 30, 2024, which is incorporated herein by reference in its entirety.

### TECHNICAL FIELD

This disclosure relates generally to transformable avatar in dressing visualization.

### BACKGROUND

Online retailers of apparel sometimes offer dressing visualization. Dressing visualization tries to simulate what a person might look like when wearing the apparel, so that the customer can determine whether to purchase the apparel.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for transformable dressing, according to an embodiment;

FIG. 4 illustrates a flow chart for a method of generating a modifiable virtual image representing a virtual model of the user wearing apparel displayed in a virtual space, according to another embodiment;

FIG. 5 illustrates an exemplary flow chart for a method of training the change model (e.g., offline change model) using the SMPLify engine to model temporal change in an offline space, such as a SMPL space;

FIG. 6 illustrates a flow chart for an activity of training the change model using a set of dataset images to generate parametrization of physiological changes over the temporal axis for multiple body types, according to an embodiment;

FIG. 7 illustrates a flow chart for an activity of updating a model for the user based on the one or more adjustments on the temporal axis and a change model trained on the temporal axis, according to another embodiment; and

FIG. 8. illustrates an example of multiple views of a dressing visualizations (e.g., upon an avatar) transformed at various shapes and sizes (e.g. BMI values) over a temporal range of time viewed by a user operating a temporal slider on a user interface, according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 1 millisecond, 1 second, 10 seconds, or another suitable time delay period.

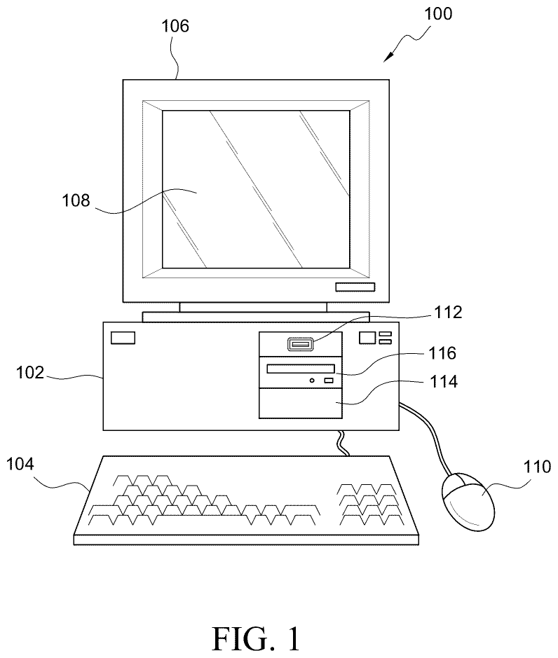

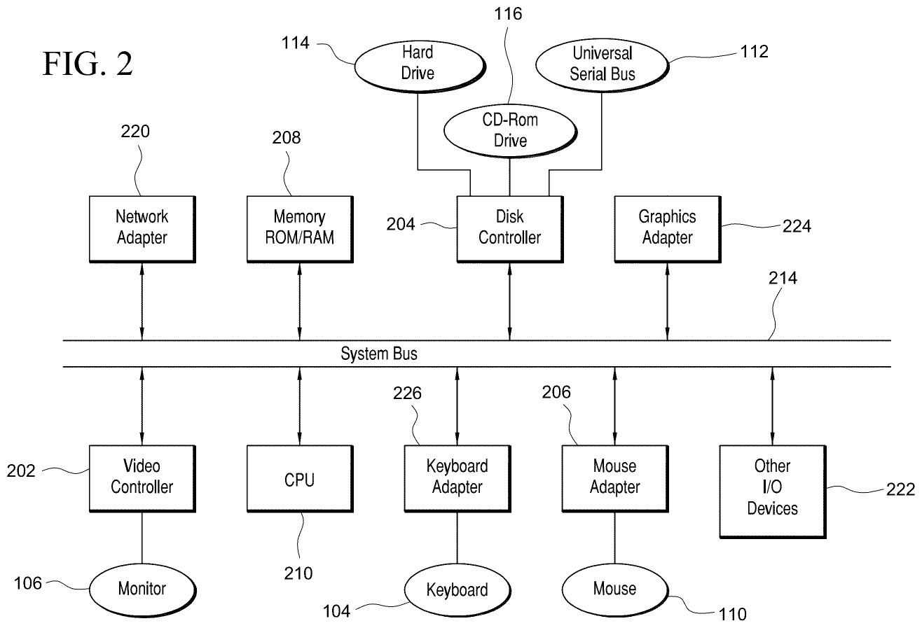

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

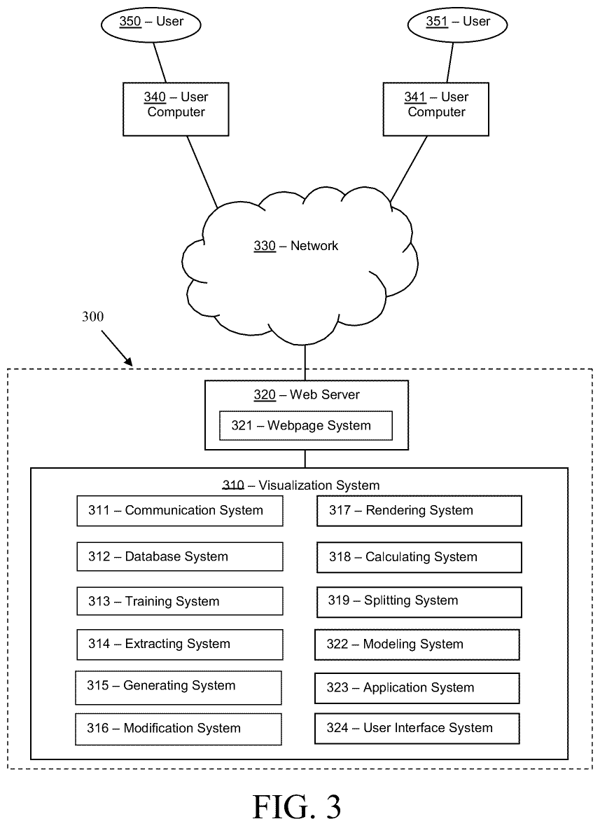

Turning ahead in the drawings, FIG. 3 illustrates a block diagram of a system 300 that can be employed for transformable dressing, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a visualization system 310 and/or a web server 320. Visualization system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, visualization system 310 and/or web server 320. Additional details regarding visualization system 310 and/or web server 320 are described herein.

In a number of embodiments, each of visualization system 310 and/or web server 320 can be a special-purpose computer programmed specifically to perform specific functions not associated with a general-purpose computer, as described in greater detail below.

In some embodiments, web server 320 and webpage system 321 can be in data communication through network 330 with one or more user computers, such as user computers 340 and/or 341. Network 330 can be a public network, a private network or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to view an interactive display, browse and/or search for items (e.g., products), to add items to an electronic shopping cart, and/or to order (e.g., purchase) items, in addition to other suitable activities.

In some embodiments, an internal network that is not open to the public can be used for communications between visualization system 310 and/or web server 320 within system 300. Accordingly, in some embodiments, visualization system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can include the Virtual Retinal Display™ product, or similar product by the University of Washington of Seattle, Washington, United States of America. Meanwhile, in further specific examples, a limb mountable wearable user computer device can include the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, network 330, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, visualization system 310 can include a communication system 311, a database system 312, a training system 313, an extracting system 314, a generating system 315, a modification system 316, a rendering system 317, a calculating system 318, a splitting system 319, a modeling system 322, an application system 323, a user interface system 324, and/or webpage system 321. In many embodiments, the systems of visualization system 310 can be modules of computing instructions (e.g., software modules) stored at non-transitory computer readable media that operate on one or more processors. In other embodiments, the systems of visualization system 310 can be implemented in hardware. Visualization system 310 can be a computer system, such as computer system 100 (FIG. 1), as described above, and can be a single computer, a single server, or a cluster or collection of computers or servers, or a cloud of computers or servers. In another embodiment, a single computer system can host visualization system 310. Additional details regarding visualization system 310 and the components thereof are described herein.

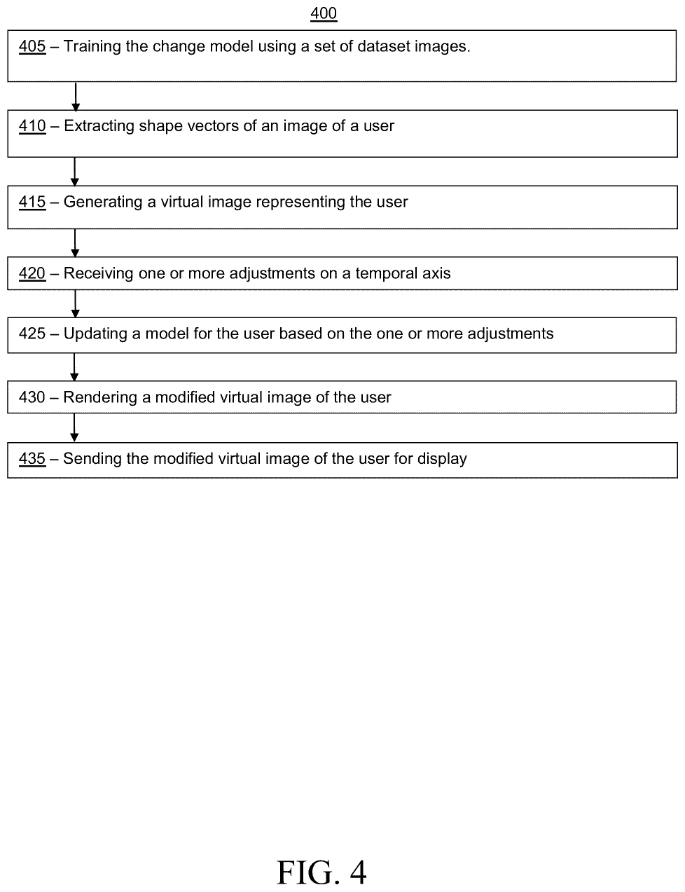

Turning ahead in the drawings, FIG. 4 illustrates a flow chart for a method 400, according to another embodiment. In some embodiments, method 400 can be a method of generating a modifiable virtual image representing a virtual model of the user wearing apparel displayed in a virtual space. In many embodiments, the modifiable virtual image is based on modifications of respective size and pose parameters using temporal parameterization of various physiological phenomena and/or physiological changes. As an example, physiological phenomena can include a pregnancy term, a Body Mass Index (BMI) change, body fat/muscle gains/losses, a time period of human growth (e.g., a baby or child), and/or another suitable type of physiological change. Method 400 is merely exemplary and is not limited to the embodiments presented herein. Method 400 can be employed in many different embodiments and/or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as visualization system 310 and/or web server 320. The processor(s) can be similar or identical to the processor(s) described above with respect to computer system 100 (FIG. 1).

In various embodiments, method 400 also can include incorporating a transformable body avatar as viewed by a user in a virtual dressing visualization space or virtual scene. Such a virtual dressing visualization space can include virtual try-on (VTO) technology and/or another suitable digital space. In some embodiments, an advantage of using a transformable body avatar for a user viewing apparel, via a dressing visualization space, is illustrated by viewing a best possible simulation of the user wearing the apparel and/or for viewing a best possible simulation of someone else wearing the apparel in the dressing visualization space. In many real-life scenarios, dimensions of a body shape and/or a pose of a user often are not constant over a respective time period where various changes can be anticipated. For example, a pregnancy term can illustrate an example of multiple dimensions of body changes anticipated or estimated over a predetermined time period. Another such example, a user can anticipate changes to body fat percentage, muscle mass percentage, and/or another suitable event related to changing body shape and/or pose over a respective time period and/or a predetermined time period set by a user.

In several embodiments, method 400 can include providing a user one or more sliders to interact with via an interactive user interface to visualizing points in time how the body avatar will appear based on various temporal changes and/or body pose views. In some embodiments, by moving the sliders in a respective direction, the slider can display incremental changes to the transformable body avatar updated as a value of the changes are selected via the position of the slider. As an example, the sliders can advantageously be configured to provide the user a view of the body avatar combined with respective apparel during incremental points in time via the temporal range of the sliders. Another advantage of using a transformable body avatar combined with dressing visualizations can include monitoring body changes updated over a time period as well as updating apparel styling, tracking changes due to changes in body mass index changes, or starting/changing a sports routine and/or training for a sports event.

In several embodiments, the system implements a significant amount of technological changes using VTO technology in order to provide an online user a method of how to experience a maximum amount of sensual information in the VTO space despite being remote from the item of interest. As an example of the maximum amount of sensual information, a visual domain can show a user the maximum amount of information by viewing different alternatives in different states of temporal changes, as described in greater detail below in at least activities 415 and/or 430 (FIG. 4).

While conventional VTO technology applications (e.g., fields) for visualizing apparel (e.g., clothing) gained some level of commercial usage by displaying plausible visualizations of user images combined with apparel images, these conventional VTO technology applications did not resolve issues specific to the fashion market such as a temporal context modification effect. In other words, a body shape (e.g., human body) can be expected to change over a predetermined time scale (e.g., period of usage) associated with changes in sizes in the fashion market unlike items like furniture or jewelry that are not expected to change passively over time.

In various embodiments, method 400 can include viewing each body shape and/or pose in the context of clothing usage where the body can undergo significant changes in dimensions reflecting simultaneous changes in apparel over time, such as pregnancy terms, changes in body fat percentage or muscle mass, growth spurts. In some embodiments, viewing a perspective of how respective body dimensions, whether increasing or decreasing, can appear virtually using an avatar wearing corresponding clothing matching the body dimensions can be advantageous to a user providing a sense of certainty about apparel fitting properly at a specific point in time. An advantage of the system is in generating an extension of this temporal extrapolation of visualization by: (i) inputting an image of the user, (ii) calculating body, shape, and/or pose parameters of the user, (iii) modeling temporal changes using an offline trained model, (iv) updating the visualization using the temporal extrapolation model, and (v) providing the user with an interactive interface of time point choices based on slider technology, as is described in greater detail below in connection with FIGS. 4-8. In some embodiments, modeling temporal change can be conducted using an offline trained model.

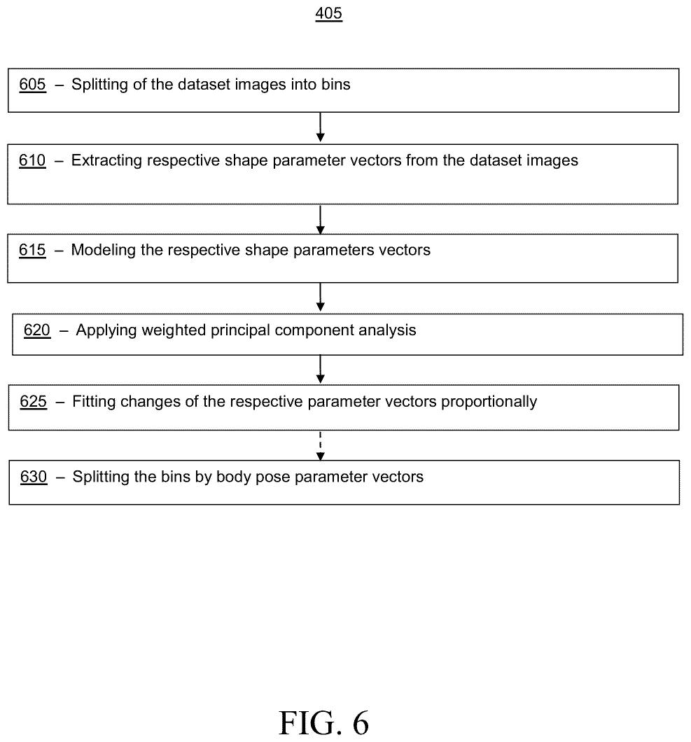

Referring to FIG. 4, method 400 can include an activity 405 of training the change model using a set of dataset images to generate parametrization of changes to the body over the temporal axis for multiple body types. Such parametrization of changes can include various physiological phenomena (e.g., physiological changes). In many embodiments, modeling the temporal changes can include creating an offline model (e.g, the change model) to generate and store images of various changes using a body modeling algorithm (e.g., tool) of a machine learning process, such as a Skinned Multi-Person Linear Model (SMPL). In several embodiments, the body modeling algorithm, such as SMPL, can include using control variables representing various dimensions of temporal changes of the physiological phenomena of the user. In some embodiments, such control variables (SMPL control variables) can include beta (β) parameters and theta (θ) parameters. As examples, changes to beta (β) parameters are responsible for changes to a weight, a shoulders breadth, a hip width, a growth chart, and/or another suitable shape parameters and/or (ii) changes of theta (θ) parameters are responsible for multiple poses. As an example, multiple poses can include different angles between arms and a torso due to modified measurements and proportions. In several embodiments, activity 405 of training the change model using a set of dataset images to generate parametrization of changes to body shape parameters and/or body pose parameters over the temporal axis for multiple poses can be implemented as described below in connection with FIG. 6.

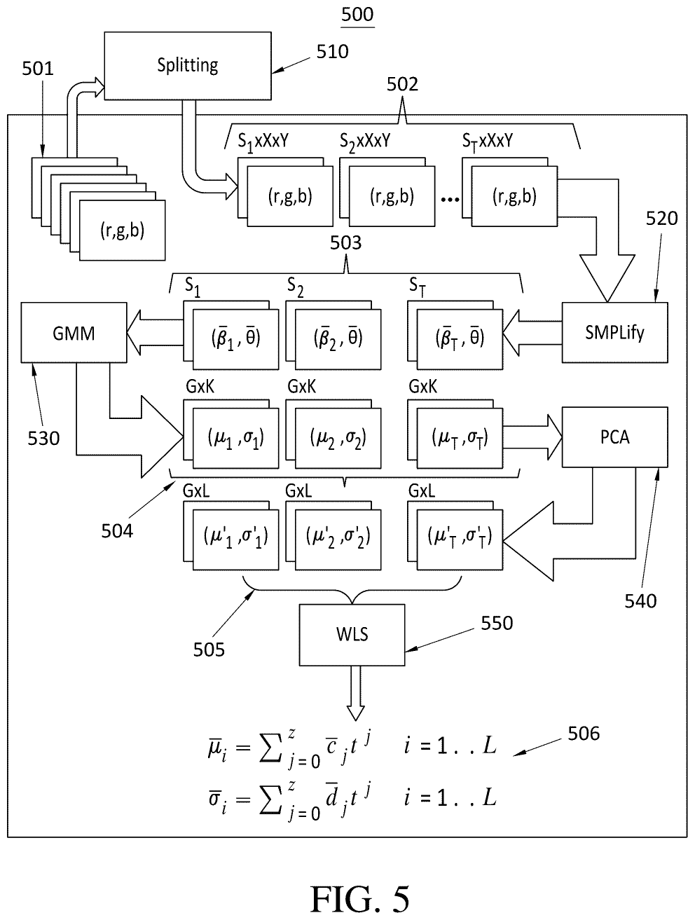

In several embodiments, method 400 can include an activity 410 of extracting shape and pose vectors of an image of a user. In some embodiments, the engine (e.g., SMPLify) that can generate an estimation of a respective body shape and pose control variables referred to respectively as, θ, β vectors within the SMPL framework in 3D out of a single 2D image, where the θ vector refers to a pose of the user and the β vector refers to a body shape. In several embodiments, using an original image of a user as input into the clothing visualization engine prior to visualization using an avatar, can provide an image of the user at an initial point in time. In various embodiments, activity 410 of extracting shape vectors and/or pose vectors from the image of a user can be similar or identical to the activities described below in connection with activity 520 (FIG. 5).

In some embodiments, method 400 also can include an activity 415 of generating a virtual image representing the user based on the shape and pose vectors and apparel of interest. In various embodiments, generating the virtual image representing the user further can be based on original image, and/or the chosen apparel. In several embodiments, the virtual image viewed can include a transformable body avatar model (e.g., avatar) representing a virtual image of the user at different temporal stages used an input into a pipeline including a dressing engine. In various embodiments, the dressing agent adds the apparel of interest on to the virtual image that is configured to be viewed together (e.g., the virtual transformable body avatar model). In some embodiments, the virtual transformable body avatar model can be viewed in several different formats and/or representations other than an image of the user. As an example of different formats and/or representations, images other than a respective user can include images of another virtual model modeling (e.g., wearing) the other apparel selections. In various embodiments, generating the avatar image can include multiple body poses based on the shape and/or pose vectors while modeling or wearing multiple sizes of apparel matching the respective the shape and pose vectors of the avatar image.

In many embodiments, generating the modifiable virtual avatar can also be implemented by using a rendering engine. In some embodiments, adding a dressing engine can be used to complete a virtual image of a user with a product in a dynamic context. In various embodiments, another advantage of viewing an image of the product dynamically, combined with the image of the user, can illustrate a respective context of usage or visualization of the product. In some embodiments, a context of usage or visualization of the product can include a static context (e.g., a product on a respective user) or a dynamic context (e.g., a product on a respective user with a BMI of X). Conventionally, complete visualization of a product with an image of a user often relied on either the user or the retailer to providing the images to the other, and either the user or the retailer combining the avatar and apparel. Such conventions can include a user providing the context body image to the retailer, where the retailer can combine it with the product making a complete visualization. Another conventional approach can include a retailer providing the product image to the user, where the user is left to combine it with the context for the user. In many embodiments, both of these conventional approaches to VTO dressing can be problematic due to potential privacy and friction issues.

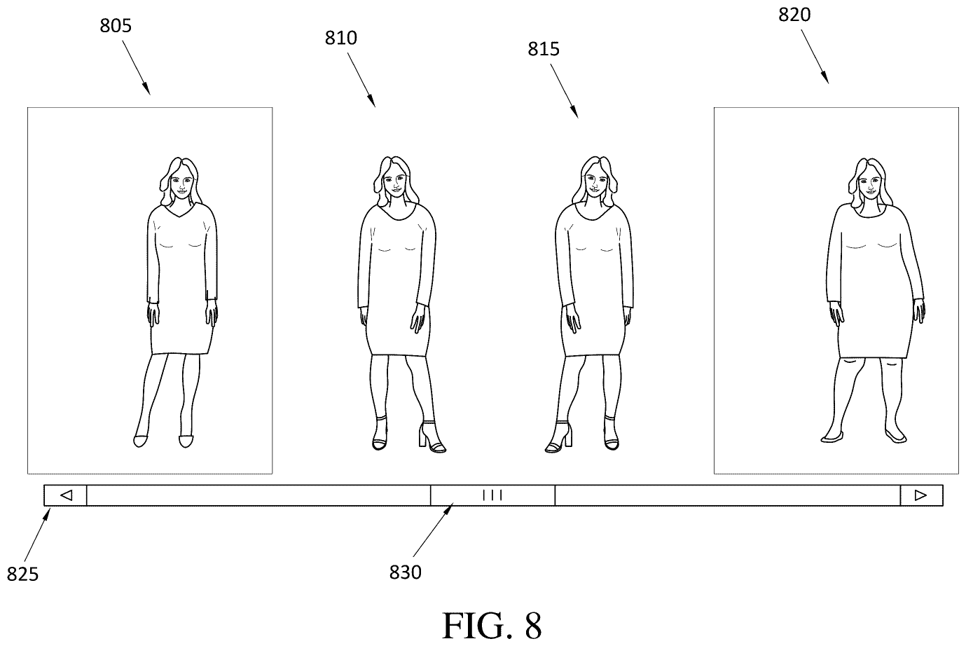

In many embodiments, method 400 additionally can include an activity 420 of receiving, from the user through an interactive user interface, one or more adjustments on a temporal axis to modify parameters of the virtual image over one or more time periods. In several embodiments, a temporal axis can be proportional to change over one or more physiological phenomena over a period of time. Such a period of time can include a pregnancy term and/or other physiological changes. In some embodiments, activity 420 can include generating a temporal axis for a user for a respective body change, such as by pregnancy, weight loss/gain, height, muscle mass, growth, etc. In some embodiments, activity 420 of receiving, from the user through an interactive user interface, one or more adjustments on a temporal axis to modify parameters of the virtual image over one or more time periods can be implemented as described below in connection with FIG. 8.

In several embodiments, activity 420 of using the interactive user interface can include generating sliders that can be configured to receive the one or more adjustments on the temporal axis to modify parameters of the virtual image in real time over the one or more time periods. In some embodiments, the virtual image can include modeling apparel matching a temporal axis read out, such as adjustments in modifiable dimensions of the body, pose, and/or apparel. In many embodiments, an interactive user interface can include more than one slider for more than one physiological phenomena, such as a respective body shape, a respective pose, and/or another suitable body avatar perspective wearing respective apparel. As an example, in case of pregnancy, a slider adjusting to a pregnancy term can include temporal units translated into various body changes displayed in increments over the term (e.g., time period). As another example, in a scenario where a user anticipates working out and gaining muscle mass over the term of a predetermined time period, an additional slider can include data for body fat percent or weight measuring units (kg/lb), which can be mapped to changes or modifications in the updated avatar based on the additional parameters, such that the updated avatar can agglomerate shape and pose parameter modifications for the multiple sliders during the update.

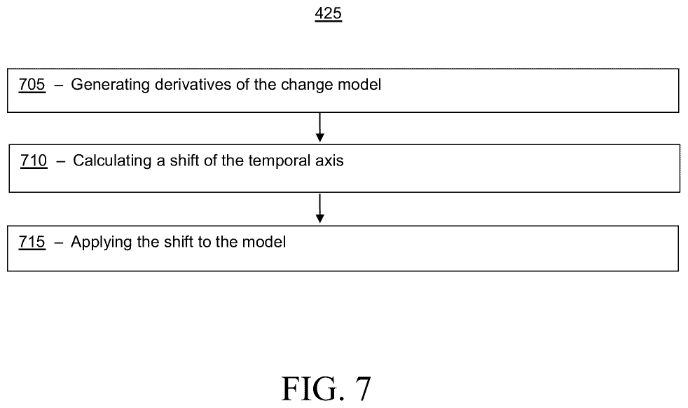

In various embodiment, method 400 also can include an activity 425 of updating a model for the user based on the one or more adjustments on the temporal axis and a change model trained on the temporal axis. In several embodiments, updating the model also can include generating, using the dressing engine, a dressing visualization displayed on a projected image of the avatar. In some embodiments, updating the model for the user further can include updating one or more model parameters based on a derived model, as described in greater detail below in connection with FIG. 7. In various embodiments, activity 425 of updating a model for the user based on the one or more adjustments on the temporal axis and a change model trained on the temporal axis can be implemented as described below in connection with FIG. 7.

In several embodiments, activity 425 also can include weighting of multiple pre-trained change models determined using a proximity of combinations of the shape parameters and/or pose parameters of the user. In some embodiments, application of SMPLify engine, to each input image can output a relevance (e.g., relevance metric value) of the pretrained G GMM models, based on its θ, β vector values distribution with respect to the ones extracted from each input image. In several embodiments, each relevance metric also can be used as a weighting of the G change models that can be derived offline into a single change model for the particular (e.g., specific) user in the input image. In some embodiments, shape and/or pose parameters of the user, such as θ, β vector values, further can used for deriving an initial temporal bin within each model. In various embodiments, the placement bin optionally can be determined manually using input from the user, which can be done in each case or when ambiguity of derivation using SMPLify parameters upon the dimensions of change exist or is higher than a predetermined threshold. In various embodiments, activity 425 of updating the model for the user based on the one or more adjustments can be implemented below in connection with FIG. 7.

In some embodiments, the change model is trained on the temporal axis for one of pregnancy, body mass index, muscle mass, fat mass, and/or another suitable physiological change.

In many embodiments, wherein the change model for the user is derived from a Gaussian Mixture Model (GMM) of the temporal change configured to output a weighted expectation of the model for the user. In some embodiments, the change model also can be derived from GMM trained offline.

In various embodiments, the model for the user is located within the change model based on the shape and pose vectors.

In several embodiments, method 400 additionally can include an activity 430 of rendering a modified virtual image of the user based on the model for the user, as updated. In some embodiments, using updated shape parameters (β′), and optionally updated pose parameters (θ′), can be used for creating (e.g., rendering) the avatar, projecting the avatar into a two dimensional (2D) image, and/or rendering an extrapolated virtual image of the user (e.g., updated) to a future point in time. In various embodiments, the extrapolated image also can be used as input into a dressing engine.

In some embodiments, method 400 further can include an activity 435 of sending the modified virtual image of the user for display on the interactive user interface. In several embodiments, movement along the temporal axis can be intuitively controlled by a slider element advantageously providing an efficient interactive experience for the user. In various embodiments, an initial position on the slider (e.g., current pregnancy week, BMI, growth) can be set through an external dialog box on a computing device operated by the user.

Moving ahead in the drawings, FIG. 5 illustrates an exemplary flow chart for a method 500 of training the change model (e.g., offline change model) using the SMPLify engine to model temporal change in an offline space, such as a SMPL space. In several embodiments, method 500 can include an activity 510 of splitting multiple images of body models of multiple users captured in varying dimensions (e.g., sizes) and/or poses across a time period at different temporal points in time while the temporal axis is used as a notion of continuous physiological change that can be stored and/or periodically updated in dataset 501. In some embodiments, the temporal axis can be used as a reference point measuring or capturing each of the images of continuous physiological changes over a respective time period. In various embodiments, activity 510 can split (e.g., segment) the images in dataset 501 into stacks of images 502 into multiple bins (e.g., T bins), where T is the number of bins, according to a temporal axis tag. In many embodiments a temporal axis tag can include a temporal parametrization period of time, such as a week or a month, and/or another suitable value along the temporal axis. In some embodiments, multiple T bins can include stacks of images that are segmented by different parameters and/or variables of the body model, such as pose. The variables S₁, S₂, to S_{T} refers to a number of images in each respective T bin wherein the number of “N” images split into T bins is expressed in the following equation: S₁+S₂+ . . . S_{T}=N, where X refers to a height and Y refers to a width of the images and r,g,b refers to color values for red, green, and blue, and r.g.b. refers to color values for red, green, and blue. In several embodiments, activity 510 can split images 502 by variables (e.g., control variables) along varying dimensions of temporal change of the model of the user. Similarly, activity 510 can split images 502 by multiple poses of the model of the user. In some embodiments, images with each bin I, where I refers to an index, can be split along additional axes providing additional degrees of model adaptability. In various embodiments, images 502 can be used as input data processed by a SMPLify engine implemented in an activity 520.

In some embodiments, method 500 can include an activity 520 of extracting SMPL parameter vectors using a SMPLify engine for each data point. Such parameter vectors can include SMPL θ̅ (e.g., length 72), β̅ (e.g, length K) parameter vectors, where θ̅ represents a pose parameter and β̅ represents a shape parameter (e.g., body shape or size). In several embodiments, activity 520 can extract dataset 503 and store each dataset into multiple T bins of combinations of SMPL θ̅, β̅ parameter vectors. Such sets can include S₁ combinations of SMPL β̅₁, θ̅, parameter vectors, S₂ combinations of SMPL β̅₂, θ̅, parameter vectors, until S_{T} combinations of SMPL β̅_{T}, θ̅, parameter vectors. In many embodiments, dataset 503 can be used as input data processed by a Gaussian Mixture Model (GMM) implemented by an activity 530. In several embodiments, T bins 503 can illustrate examples of body and pose parameter configurations that can be characteristic to T points along the temporal axis denoting continuous physiological change.

In various embodiments, method 500 can include activity 530 of modeling vector βᵢ within each bin I per vector by GMM, where I refers to an index. In some embodiments, activity 530 can generate T bins 504 of G×K combinations, where G refers to an amount of Gaussian distributions within a bin and K refers a length of representation vector for expectation and variance of each distribution. Such sets can include G combinations of μᵢ, σᵢ for bin I, where refers to an expectation vector of length K and a refers to a variance of length K, denoted by μᵢ, σ₁, μ₂, σ₂, and so forth to a total number of T sets, μ_{T}, σ_{T}. In several embodiments, T bins 504 can illustrate examples of modeling of the images within each of the T bins by G multi-dimensional Gaussians approximating the distribution of the SMPL parameters as extracted from the images.

In various embodiments, method 500 can include activity 540 of implementing Principal Component Analysis (PCA), which can input dataset 504 and output dataset 505 limiting the dimensionality of the Gaussian parameters (K) to L dimensions. In some embodiments, T bins 505 can include G combinations of μᵢ′, σᵢ, for bin I, where μ′ refers to expectation vector of length L and σ′ refers to variance vector of length L, denoted by μ′₁, σ′₁, μ′₂, σ′₂, and so forth to a total number of T sets, μ′_{T}, σ′_{T}. In several embodiments, T bins 505 illustrate modeling of the images within each of the T bins by G multi-dimensional Gaussians of limited dimensionality L, per specific physiologic phenomenon.

In various embodiments, method 500 can include activity 550 of using Weighted Least Squares (WLS) fitting. In some embodiments, using WLS fitting can input dataset 505 and output fitting models 506 that can model the variation of the Gaussian parameters along the temporal axis by a polynum (of rank Z (possessing Z+1 terms)) with coefficients c̅ⱼ, d̅ⱼ of dimension G. The variances of the fitted GMM model can be used for the weighting of the T sets in 505 for polynum fitting of each dimension 1 . . . L in each change model 1 . . . within 506. In many embodiments, output change models 506 can be described by at least equation 1 and/or equation 2:

$${\overline{μ}}_{i} = {\sum }_{j = 0}^{z} {\overline{c}}_{j} {t}^{j} i = 1 ¨ L \qquad equation 1$$

$${\overline{σ}}_{i} = {\sum }_{j = 0}^{z} {\overline{d}}_{j} {t}^{j} i = 1 ¨ L \qquad equation 2$$

where, μ̅ᵢ refers to G polynums temporally fitting G×T Gaussian means of the i-th of L dimensions of PCA's output, z refers to polynum's rank, c refers to G dimensional polynum's coefficient vector for fitting of Gaussian means, j refers to polynum's term, t refers to temporal dimension unit, σ̅ᵢ refers to G polynums temporally fitting G×T Gaussian variances of the i-th of L dimensions of PCA's output, and d refers to G dimensional polynum's coefficient vector for fitting of Gaussian variances.

In some embodiments, 506 alternatively or optionally can contain a different amount of change models than G, through further integration of the G gaussians. In several embodiments, fitting models 506 can illustrate a plurality of change models along the temporal axis present in the training dataset within projected sub-space of SMPL parameters.

Turning ahead in the drawings, FIG. 6 illustrates a flow chart for activity 405 of training the change model using a set of dataset images to generate parametrization of physiological changes over the temporal axis for multiple body types, according to an embodiment. Activity 405 can be employed in many different embodiments and/or examples not specifically depicted or described herein. In some embodiments, the procedures, the processes, and/or the activities of activity 405 can be performed in the order presented or in parallel. In other embodiments, the procedures, the processes, and/or the activities of activity 405 can be performed in any suitable order. In still other embodiments, one or more of the procedures, the processes, and/or the activities of activity 405 can be combined or skipped. In several embodiments, system 300 (FIG. 3) can be suitable to perform activity 405 and/or one or more of the activities of activity 405.

In these or other embodiments, one or more of the activities of activity 405 can be implemented as one or more computing instructions configured to run at one or more processors and configured to be stored at one or more non-transitory computer-readable media. Such non-transitory computer-readable media can be part of a computer system such as visualization system 310 and/or web server 320. The processor(s) can be similar or identical to the processor(s) described above with respect to computer system 100 (FIG. 1).

Referring to FIG. 6, activity 405 can include an activity 605 of splitting of the dataset images into bins along the temporal axis. In some embodiments, prior to splitting the dataset images, activity 605 can begin by receiving a collection of images for a dataset. Such a collection of images can include a diverse array of images that reflect changes on a temporal axis describing the physiological phenomena. For example, an axis of change can reference a predetermined period of time such as a pregnancy term, a weight loss span of time, and/or another suitable period of time measuring body shape changes and/or pose changes. Such changes can be associated with changes, such as a week of pregnancy, a body fat percentage, a BMI score, etc. In several embodiments, activity 605 of splitting of the dataset images into T bins can be similar or identical to the activities described above in connection with activity 510 (FIG. 5).

In various embodiments, activity 605 can include splitting the dataset images into bins or stacks along the axis of change into T bins. In some embodiments, splitting can be include: (T bins of Sᵢ X×Y×3 images), where the Sᵢ can refer to an amount of images in a bin I, X can refer to height, Y can refer to width, and 3 images can refer to RGB (e.g., red, green, blue)

In several embodiments, activity 405 can include an activity 610 of extracting respective shape and/or pose parameter vectors from the dataset images. In some embodiments, the dataset images can be used as input data used to train the change model. In various embodiments, extracting the respective shape and/or pose parameter vectors can be performed using a skinned multi-person linear model engine (SMPLify). In many embodiments, applying the SMPLify engine to extract SMPL parameter vectors can include θ of 72 and, β of K dimensions (e.g., shapes) for each data point. In some embodiments, extracting the respective shape and pose parameter vectors can include: (T bins of Si combinations of θ vectors of 72 elements and β vectors of K elements). In several embodiments, activity 605 of extracting respective shape and/or pose parameter vectors can be similar or identical to the activities described above in connection with activity 410 (FIG. 4) and/or activity 520 (FIG. 5).

In some embodiments, activity 405 additionally can include an activity 615 of modeling the respective shape parameters vectors using a set of Gaussian Mixture Models (GMM). In several embodiments, modeling the respective shape parameters can include (T bins of G×K combinations of expectations and variances), wherein G refers to an amount of Gaussians in the model, K refers an amount of shape parameters 3. In many embodiments, activity 615 of modeling the respective shape parameters vectors can be similar or identical to the activities described above in connection with activity 530 (FIG. 5).

In many embodiments, activity 405 further can include an activity 620 of applying weighted principal component analysis to the Gaussian Mixture Models. In some embodiments, activity 620 can include implementing weighted Principal Component Analysis (PCA) upon the T bins based on (i) GMMs expectation and variance parameters (G×K) and (ii) leaving G vectors of length (L). In several embodiments, the weighting can make use of inter and/or intra variances of each of the K dimensions of vector β.

In some embodiments, activity 620 can optionally include implementing an engineered curation of the PCA results, decreasing effect of possible dataset imbalance along irrelevant axis and removing some of the chosen L dimensions. As an example, if a height shape vector element appears significant in a pregnancy dimension estimation, the system can exclude the height shape vector element from PCA subspace determining that the vector element was an output of a data bias rather than an actual phenomenon. In many embodiments, implementing an engineered curation of the PCA output (e.g., results) can include: (T bins of G×L′ combinations of expectations and variance (L′<L<K)) where L is chosen out of K by PCA and further curated to a subset L′. In several embodiments, implementing an engineered curation of the PCA result can be included within activities described above in connection with activity 540 (FIG. 5).

In various embodiments, activity 405 of training the change model also can include an activity 625 of fitting changes of the respective parameter vectors proportionally along the temporal axis. In some embodiments, fitting a change of selected principal elements of the parameters vector (β) along the T bins temporal indices proportional to the axis of change can include using Z+1 coefficients. In some embodiments, fitting changes of the respective parameter vectors also can include: ((Z+1)×G×L′ coefficients' parameters), where Z refers to a polynum degree of the model fitted to the T points of G×L′ dimensionality. In various embodiments, dimensionality optionally and/or alternatively further can be reduced to G′×L′ with additional integration of the G change models. In several embodiments, fitting changes of the respective parameter vectors can be similar or identical to the activities described above in connection with activity 550 (FIG. 5).

In a number of embodiments, activity 405 additionally and optionally can include an activity 630 of splitting the T bins by body pose parameter vectors. In several embodiments, activity 630 can include further splitting of the T bins by pose parameters vector (θ), allowing plurality of change models (e.g., 6 change models) per each pose of the user.

Turning ahead in the drawings, FIG. 7 illustrates a flow chart for activity 425 of updating a model for the user based on the one or more adjustments on the temporal axis and a change model trained on the temporal axis, according to another embodiment. Activity 425 can be employed in many different embodiments and/or examples not specifically depicted or described herein. In some embodiments, the procedures, the processes, and/or the activities of activity 425 can be performed in the order presented or in parallel. In other embodiments, the procedures, the processes, and/or the activities of activity 425 can be performed in any suitable order. In still other embodiments, one or more of the procedures, the processes, and/or the activities of activity 425 can be combined or skipped. In several embodiments, system 300 (FIG. 3) can be suitable to perform activity 425 and/or one or more of the activities of activity 425.

In these or other embodiments, one or more of the activities of activity 425 can be implemented as one or more computing instructions configured to run at one or more processors and configured to be stored at one or more non-transitory computer-readable media. Such non-transitory computer-readable media can be part of a computer system such as visualization system 310 and/or web server 320. The processor(s) can be similar or identical to the processor(s) described above with respect to computer system 100 (FIG. 1).

Referring to FIG. 7, activity 425 can include an activity 705 of generating derivatives of the change model calculated at a first point in time. In various embodiments, each point of calculation keeps changing over time. In some embodiments, with each shift on a temporal axis, the derivatives can be updated according to models fitted during the training of the change model during the offline modeling stage at a new point in time.

In several embodiments, activity 425 additionally can include an activity 710 of calculating a shift of the temporal axis to a second point in time for the derivatives of the change model. In some embodiments, derivatives of the fitted models can be calculated at a current point in time and used to calculate the necessary shift towards the next point in time.

In some embodiments, activity 425 also can include an activity 715 of applying the shift to the model for the user. In several embodiments, as the fitted models are evaluated in PCA subspace, the SMPL model of the user can be projected prior to application of the shift. In various embodiments, the shift can be applied in the PCA subspace upon the projected SMPL model of the user and then the model can be re-projected back to the SMPL space. In some embodiments, after the re-projection, relative placement parameters can be applied for weighting of the G change variants according to G gaussians the GMM model, by position of the SMPL parameters of the user within these of the G gaussians (β′).

Turning ahead in the drawings, FIG. 8. illustrates an example of multiple views of a dressing visualizations (e.g., upon an avatar) transformed at various shapes and sizes (e.g. BMI values) over a temporal range of time viewed by a user operating a temporal slider on a user interface, according to an embodiment. FIG. 8 also can include examples of multiple images of the body avatar viewed at different stages of change, such as images 805, 810, 815, and 820. In some embodiments, a slider bar 825 representing a temporal period of time (e.g., a range of time) can be added to a user interface where the user can operate slider bar 825 by moving slider 830 in either direction so show each example of a different body avatar image based on the position of slider 830. As an example, moving slider 830 to a left position can illustrate a sequential range of smaller values such as sizes or shapes (e.g., values of BMI of the model) as opposed to larger sizes of the avatar modeling apparel and moving slider 830 to the right can illustrate another sequential range of larger values such as sizes and shapes compared to the smaller sizes, and vice versa. In several embodiments, more than one slider bar, such as slider bar 825, can be added to the user interface to show multiple poses (e.g., parameters) of the visualization e.g. body avatar) transformed and/or modified at various shapes and sizes (e.g., modified) for the temporal range of time also by moving a slider in either direction from smaller to larger shapes and sizes.

Returning to the FIG. 3, in a number of embodiments, communication system 311 can at least partially perform activity 420 (FIG. 4) receiving, from the user through an interactive user interface, one or more adjustments on a temporal axis to modify parameters of the virtual image over one or more time periods.

In many embodiments, database system 312 can at least partially perform input and storage of dataset 501.

In various embodiments, training system 313, also can at least partially perform activity 405 (FIG. 4) of training the change model using a set of dataset images to generate parametrization of changes to body shapes over the temporal axis for multiple body types, activity 705 (FIG. 7) of generating derivatives of the change model calculated at a first point in time, and/or activity 715 (FIG. 7) of applying the shift to the model for the user.

In some embodiments, extracting system 314 can at least partially perform activity 410 (FIG. 4) of extracting shape and pose vectors of an image of a user, activity 520 (FIG. 5) of extracting Skinned Multi-Person Linear Model (SMPL) parameter vectors for each data point, and/or activity 610 (FIG. 6) of extracting respective shape and post parameter vectors from the dataset images.

In several embodiments, generating system 315 can at least partially perform activity 415 (FIG. 4) of generating a virtual image representing the user based on the shape and pose vectors and an apparel of interest.

In many embodiments, modification system 316 can at least partially perform activity 425 (FIG. 4) of updating a model for the user based on the one or more adjustments on the temporal axis and a change model trained on the temporal axis.

In some embodiments, rendering system 317 can at least partially perform activity 430 (FIG. 4) of rendering a modified virtual image of the user based on the model for the user, as updated, and the apparel of interest.

In several embodiments, calculating system 318 can at least partially perform activity 710 (FIG. 7) of calculating a shift of the temporal axis to a second point in time for the derivatives of the change model.

In various embodiments, splitting system 319 can at least partially perform activity 510 (FIG. 5) of splitting multiple images of body models of multiple users captured in varying dimensions (e.g., sizes) and/or poses across a time period at different temporal points in time while the temporal axis is used as a notion of continuous physiological change that can be stored and/or periodically updated in dataset 501, activity 605 (FIG. 6) of splitting of the dataset images into bins along the temporal axis, and/or activity 630 (FIG. 6) of splitting the bins by body pose parameter vectors.

In some embodiments, modeling system 322 can at least partially perform activity 530 (FIG. 5) of modeling vector βᵢ within each bin I per vector by GMM, activity 615 (FIG. 6) of modeling the respective shape and pose parameter vectors using a set of Gaussian Mixture Models, activity 550 (FIG. 5) of using Weighted Least Squares (WLS) fitting, and/or activity 625 (FIG. 6) of fitting changes of the respective shape and pose parameter vectors proportionally along the temporal by weighted least squares fitting.

In many embodiments, application system 323 can at least partially perform activity 620 (FIG. 6) of applying weighted principal component analysis to the Gaussian Mixture Models, and/or activity 540 (FIG. 5) of implementing Principal Component Analysis (PCA), which can input dataset 504 and output dataset 505 limiting the dimensionality of the Gaussian parameters to L dimensions.

In various embodiments, user interface system 324 can at least partially perform activity 435 (FIG. 4) of sending the modified virtual image of the user for display on the interactive user interface.

In several embodiments, webpage system 321 can at least partially perform sending instructions to user computers (e.g., 350-351 (FIG. 3)) based on information received from communication system 311.

In many embodiments, the techniques described herein can be used continuously at a scale that cannot be handled using manual techniques. For example, the number of daily and/or monthly visits to a webpage or website can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as determining whether to select respective apparel at a respective future period of time based on a transformable body does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because a vendor catalog, such as an online catalog, that can power and/or feed an online website that is part of the techniques described herein would not exist.

In several embodiments, the system provides an advantageous solution over conventional methods by allowing a temporal extension of dressing visualization based on multiple considerations of expected physical changes of the body within a time frame. Such advantages can include superior relevance of simulation imaging for usage increment and user preference. Another advantage can be illustrated by identifying a behavior trigger based on the extrapolated visualization that opens an opportunity for targeted recommendations driven by the behavior. Such examples of targeted behavior can include a focused clothing (pregnancy, sport) on a single item level or entire outfit or a focus on nutrition common to respective users.

On the technology side, the concept building blocks are advantageous illustrated by the integration of body shape, modified according to temporal modeling of physical change, with fashion visualization applications as a novel concept in this technology field.

Various embodiments can include a system including a processor and a non-transitory computer-readable media storing computing instructions that, when executed on the processor, cause the processor to perform certain operations. The operations can include extracting shape and pose vectors of an image of a user. The operations also can include generating a virtual image representing the user based on the shape and pose vectors and apparel of interest. The operations further can include receiving, from the user through an interactive user interface, one or more adjustments on a temporal axis to modify parameters of the virtual image over one or more time periods. The operations additionally can include updating a model for the user based on the one or more adjustments on the temporal axis and a change model trained on the temporal axis. The operations further can include rendering a modified virtual image of the user based on the model for the user, as updated, and the apparel of interest. The operations also can include sending the modified virtual image of the user for display on the interactive user interface.

A number of embodiments can include a computer-implemented method. The method can include extracting shape and pose vectors of an image of a user. The method also can include generating a virtual image representing the user based on the shape and pose vectors and apparel of interest. The method further can include receiving, from the user through an interactive user interface, one or more adjustments on a temporal axis to modify parameters of the virtual image over one or more time periods. The method additionally can include updating a model for the user based on the one or more adjustments on the temporal axis and a change model trained on the temporal axis. The method further can include rendering a modified virtual image of the user based on the model for the user, as updated, and the apparel of interest. The method also can include sending the modified virtual image of the user for display on the interactive user interface.

Additional embodiments can include a non-transitory computer-readable media storing computing instructions that, when executed on a processor, cause the processor to perform certain operations. The operations can include extracting shape and pose vectors of an image of a user. The operations also can include generating a virtual image representing the user based on the shape and pose vectors and apparel of interest. The operations further can include receiving, from the user through an interactive user interface, one or more adjustments on a temporal axis to modify parameters of the virtual image over one or more time periods. The operations additionally can include updating a model for the user based on the one or more adjustments on the temporal axis and a change model trained on the temporal axis. The operations further can include rendering a modified virtual image of the user based on the model for the user, as updated, and the apparel of interest. The operations also can include sending the modified virtual image of the user for display on the interactive user interface.

Although generating a virtual transformable body avatar in a virtual transformation dressing visualization has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 4-7 may include different procedures, processes, and/or activities and be performed by many different modules, in many different orders, and/or one or more of the procedures, processes, or activities of FIGS. 4-7 may include one or more of the procedures, processes, or activities of another different one of FIGS. 4-7. As another example, visualization system 310, communication system 311, database system 312, training system 313, extracting system 314, generating system 315, modification system 316, rendering system 317, calculating system 318, splitting system 319, modeling system 322, application system 323, user interface system 324, webserver 320 and/or webpage system 321. Additional details regarding visualization system 310, communication system 311, database system 312, training system 313, extracting system 314, generating system 315, modification system 316, rendering system 317, calculating system 318, splitting system 319, modeling system 322, application system 323, and/or user interface system 324 (see FIGS. 3 and 7) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
extracting shape and pose vectors of an image of a user;
generating a virtual image representing the user based on the shape and pose vectors and apparel of interest;
receiving, from the user through an interactive user interface, one or more adjustments on a temporal axis to modify parameters of the virtual image over one or more time periods;
updating a model for the user based on the one or more adjustments on the temporal axis and a change model trained on the temporal axis;
rendering a modified virtual image of the user based on the model for the user, as updated, and the apparel of interest; and
sending the modified virtual image of the user for display on the interactive user interface.

2. The system of claim 1, wherein the change model is trained on the temporal axis for one or more physiological changes.

3. The system of claim 1, wherein the change model for the user is derived from a Gaussian Mixture Model configured to output a weighted expectation of the change model for the user.

4. The system of claim 1, wherein the change model for the user is located within the change model based on the shape and pose vectors.

5. The system of claim 1, wherein the interactive user interface comprises a slider configured to receive the one or more adjustments on the temporal axis to modify the parameters of the virtual image over the one or more time periods.

6. The system of claim 1, wherein the operations further comprise:
training the change model using a set of dataset images to generate parametrization of changes to body shapes over the temporal axis for multiple body types.

7. The system of claim 6, wherein training the change model comprises:
splitting the dataset images into bins along the temporal axis;
extracting respective shape and pose parameter vectors from the dataset images;
modeling the respective shape and pose parameter vectors using a set of Gaussian Mixture Models;
applying weighted principal component analysis to the Gaussian Mixture Models; and
fitting changes of the respective shape and pose parameter vectors proportionally along the temporal axis by weighted least squares fitting.

8. The system of claim 7, wherein extracting the respective shape and pose parameter vectors is performed by a skinned multi-person linear model engine (SMPLify).

9. The system of claim 7, wherein training the change model further comprises:
segmenting the bins by body pose parameter vectors.

10. The system of claim 1, wherein updating the model for the user further comprises:
generating derivatives of the change model calculated at a first point in time;
calculating a shift of the temporal axis to a second point in time for the derivatives of the change model; and
applying the shift to the model for the user.

11. A computer-implemented method comprising:
extracting shape and pose vectors of an image of a user;
generating a virtual image representing the user based on the shape and pose vectors and apparel of interest;
receiving, from the user through an interactive user interface, one or more adjustments on a temporal axis to modify parameters of the virtual image over one or more time periods;
updating a model for the user based on the one or more adjustments on the temporal axis and a change model trained on the temporal axis;
rendering a modified virtual image of the user based on the model for the user, as updated, and the apparel of interest; and
sending the modified virtual image of the user for display on the interactive user interface.

12. The computer-implemented method of claim 11, wherein the change model is trained on the temporal axis for one or more physiological changes.

13. The computer-implemented method of claim 11, wherein the change model for the user is derived from a Gaussian Mixture Model configured to output a weighted expectation of the change model for the user.

14. The computer-implemented method of claim 11, wherein the change model for the user is located with the change model based on the shape and pose vectors.

15. The computer-implemented method of claim 11, wherein the interactive user interface comprises a slider configured to receive the one or more adjustments on the temporal axis to modify the parameters of the virtual image over the one or more time periods.

16. The computer-implemented method of claim 11 further comprising:
training the change model using a set of dataset images to generate parametrization of changes to body shapes over the temporal axis for multiple body types.

17. The computer-implemented method of claim 16, wherein training the change model comprises:
splitting the dataset images into bins along the temporal axis;
extracting respective shape and pose parameter vectors from the dataset images;
modeling the respective shape and pose parameters vectors using a set of Gaussian Mixture Models;
applying weighted principal component analysis to the Gaussian Mixture Models; and
fitting changes of the respective shape and pose parameter vectors proportionally along the temporal axis by weighted least squares fitting.

18. The computer-implemented method of claim 17, wherein extracting the respective shape and pose parameter vectors is performed by a skinned multi-person linear model engine (SMPLify).

19. A non-transitory computer-readable medium storing computing instructions that, when executed on a processor, cause the processor to perform operations comprising:
extracting shape and pose vectors of an image of a user;
generating a virtual image representing the user based on the shape and pose vectors and apparel of interest;
receiving, from the user through an interactive user interface, one or more adjustments on a temporal axis to modify parameters of the virtual image over one or more time periods;
updating a model for the user based on the one or more adjustments on the temporal axis and a change model trained on the temporal axis;
rendering a modified virtual image of the user based on the model for the user, as updated, and the apparel of interest; and
sending the modified virtual image of the user for display on the interactive user interface.

20. The non-transitory computer-readable medium of claim 19, wherein the change model is trained on the temporal axis for one or more physiological changes.
